(19) United States
(12) Patent Application Publication
(10) Pub. No.: US 2021/0120832 A1
(43) Pub. Date: Apr. 29, 2021

(54) HIGH-BIOACTIVITY BLACK DRY APPLE CHIP AND PROCESSING TECHNOLOGY THEREOF

(71) Applicants: SDIC ZHONGLU FRUIT JUICE CO., LTD., BEIJING (CN); RUSHAN ZHONGCHENG FRUIT JUICE BEVERAGE CO., LTD, Weihai (CN)

(72) Inventors: Jiming ZHANG, BEIJING (CN); Chuanzhu LENG, BEIJING (CN); Xinfei SONG, WEIHAI (CN); Jiangming FAN, WEIHAI (CN); Sixin WANG, BEIJING (CN); Baoshuang TIAN, BEIJING (CN); Xiaotong CHEN, BEIJING (CN); Xihong LI, BEIJING (CN); Luyin WANG, BEIJING (CN); Yi ZHU, BEIJING (CN); Meng WANG, BEIJING (CN); Chunhui HOU, BEIJING (CN); Genlin GUO, BEIJING (CN)

(73) Assignees: SDIC ZHONGLU FRUIT JUICE CO., LTD.; RUSHAN ZHONGCHENG FRUIT JUICE BEVERAGE CO., LTD

(21) Appl. No.: 16/858,578

(22) Filed: Apr. 24, 2020

(30) Foreign Application Priority Data
Oct. 25, 2019 (CN) 201911020603.7

(51) Int. Cl. A23B 7/155; A01N 63/22; A23N 7/02; A23N 12/02; A23L 19/00; A23B 7/02

(52) U.S. Cl. CPC A23B 7/155; A01N 63/22; A23N 7/02; A23V 2002/00; A23L 19/03; A23B 7/02; A23N 12/023

(57) ABSTRACT

The disclosure relates to a high-bioactivity black dry apple chip and a processing technology thereof. The processing process is as follows: fresh fruits→sorting→peeling→slicing→fermenting→drying→packaging→black dry apple chips. According to the disclosure, a high-temperature Bacillus subtilis fermentation broth atomization spray technology is adopted to atomize the processed apple slices under the condition of 60° C.-80° C., the cut apple slices are irradiated with 60 Coy rays at a dose of 4 kGy to promote carbonyl ammonia reaction so as to make apple slices generate burnt black. According to the disclosure, Bacillus subtilis antimicrobial peptide solution is sprayed so as to utilize its bacteriostatic function to avoid pathogen infection during shelf life.

### CROSS-REFERENCE TO RELATED APPLICATIONS

This application claims priority to Chinese Patent Application No. 201911020603.7 with a filing date of Oct. 25, 2019. The content of the aforementioned applications, including any intervening amendments thereto, are incorporated herein by reference.

### TECHNICAL FIELD

The disclosure relates to dry apple chips, and particularly relates to a high-bioactivity black dry apple chip and a processing technology thereof.

### BACKGROUND OF THE PRESENT INVENTION

Xinjiang Aksu tangxin apple is sweet, thick in taste, juicy without dregs, and rich in nutrition. Melanoidins generated from carbonyl ammonia reaction is capable of resisting oxidation, free radicals and diseases, and can improve activity after being combined with enzyme. The freshly cut Aksu tangxin apple produces unique fragrance and color through carbonyl ammonia reaction and has the functions of antioxidation and high activity. At present, carbonyl ammonia reaction is mostly carried out naturally under the conditions of high temperature and high humidity, with long time and uneven color. There are few technologies for producing enzyme substances utilizing microorganisms to promote the carbonyl ammonia reaction of apple. There are few technologies for producing black apple chips utilizing biological agents in the market. The current technology for making black apples has the following defects.

(1) In the process of carbonyl ammonia reaction, protein is combined with sugar, amino acid is combined with sugar, the combined products are not easily be used by enzymes, and nutritional ingredients are not easily digested.

(2) The making process of black chips is long in time and generates harmful substances due to unstable control of its temperatures and humidity.

(3) In the market, bacteriostat and disease resisting function of Bacillus subtilis is mostly utilized to act on crops, but there are few studies on promotion carbonyl ammonia reaction utilizing screrase while inhibiting harmful substances and pathogenic bacteria.

(4) The freeze-drying technology in processing takes long time, and is high in cost and not suitable for processing a large amount of dry chips like apples; the spray drying technology is high in temperature, and can generate instability and ingredient substances affecting product components in the process of drying, leading to loss of nutrient substances.

(5) The sugar content of tangxin apple is high, and the slices are easily agglomerated, adhered and absorb moisture in the process of drying, resulting in poor product quality.

After retrieval, the patents related to this application are as follows:

1. A method of making non-fried puffed Hanfu apple chips (CN 104872564 A). The disadvantages of this patent are as follows: \textcircled{1} when slicing, the blade directly cuts the apple, and the cell fluid inside the apple flows out, which extremely leads to the growth of pathogenic bacteria; \textcircled{2} during the stage of sugar boiling, the defensive enzyme activity such as SOD is destroyed while destroying the enzyme activity that is prone to browning; \textcircled{3} the hot air drying takes a long time and the change in ingredients of the apple slice is not well controlled in the process of drying.

2. A rapid preparation method of non-puffing low-sugar freeze-dried fruit chips (CN 101433300A). The disadvantages are as follows: \textcircled{1} when slicing, the blade directly cuts the apple and the cell fluid inside the apple flows out, which easily leads to the growth of pathogenic bacteria; \textcircled{2} the selected low-sugar fruits contact with oxygen to easily generate browning; in the stage of microwave drying, the puffing degree is not stable, and there is the possibility of fruit chips puffing; \textcircled{3} in the stage of sublimation drying, the freeze-drying means is large in energy consumption, which increases the cost of dry chips.

3. A preparation method of freeze-dried Momordica grosvenorii (CN 102224838 A). The disadvantages are as follows: \textcircled{1} vacuum freeze-drying is long in time and large in energy consumption, although the whole Momordica grosvenori fruit is preserved for drying, but the cost of Momordica grosvenori fruit is increased; \textcircled{2} in the process of heating, heating in stages is too frequent, which increases the complexity of the process and is not conducive to batch production. \textcircled{3} During the period of preserving the whole fruit, pathogens are easily introduced and difficultly controlled because of punching on the fruits.

### SUMMARY OF PRESENT INVENTION

The object of the disclosure is to provide a high-bioactivity black dry apple chip, which is simple in making process and high in efficiency, and a processing technology thereof, in order to overcome the disadvantages of the prior art.

The technical solution to be achieved by the disclosure is as follows:

A processing method of a high-bioactivity black dry apple chip, wherein specific process requirements and parameters are as follows:

(1) sorting: selecting fresh and high-quality tangxin apples with no disease and pest invasion, no mechanical damage and roughly same fruit maturity;

(2) cleaning and peeling: under the running tap water, washing away the soil on the surface of apples, wiping the water drop, and peeling off the skin;

(3) slicing: slicing the apple to a thickness of 2 mm by using an ultra-high pressure water jet cutting technology;

(4) fermenting: atomizing the two sides of the apple slice under the condition of 60° C.-80° C. using a high-temperature Bacillus subtilis fermentation broth atomization spray technology, irradiating the cut apple slices with 60 Coy rays at a dose of 4 kGy to promote carbonyl ammonia reaction so as to make the apple slices generate burnt black;

(5) drying: a radio frequency-pulse vacuum dehumidification plate type drying technology is adopted, the vaccumizing combined with radio frequency is 30 MHz, and the radio frequency power is 5 kW pulse. Through the dehumidification plate type drying technology, the black apple slices are intermittently heated and dried, the heating temperature is 45° C., and the intermittently alternating time is 60 s.

(6) Packaging: packaging to obtain black apple chips.

Furthermore, when the fermentation temperature is 85˜89° C. and the steam pressure is 0.3˜4 MPa, the pressure is instantly reduced to −0.08 MPa, and the temperature is decreased to 75° C., lasting for 1.5 h.

Furthermore, maltodextrin powder is sprayed in the process of drying.

The disclosure has the advantages and beneficial effects:

1. Bacillus subtilis antimicrobial peptide solution is sprayed so as to utilize its bacteriostatic function to avoid pathogen infection during shelf life; Bacillus subtilis has the function of producing amylase and protease in high yield, and thus carbonyl ammonia reaction of apple slices is promoted by sufficiently utilizing the characteristics of enzyme production and adopting the high-yield α-amylase Bacillus subtilis atomizing fermentation technology; in addition, Bacillus subtilis is conducive to maintaining the activity of a defensive enzyme system.

2. The disclosure adopts a radio frequency-pulse vacuum dehumidification plate type pre-drying combined with differential pressure puffing technology. Pulse radio frequency is large in penetrating capability and uniform in heating and meanwhile addition of maltodextrin can effectively solve the problem that apple slices are adhered due to high content of sugar, improve the retention and uniformity of nutritional components of dried products, and also can significantly shorten the drying time by about 50%.

3. The differential pressure puffing operation temperature adopted by the disclosure is too low, the puffing degree is low, the appearance and crispness of apple chips are poor, and when the operation temperature is too high, coking is easy to occur. The combination of the two can overcome the problems of “hard core” and “coking” caused by radio frequency pulse and differential pressure puffing.

### DESCRIPTION OF THE DRAWINGS

FIG. 1 is an apple slice in the process of preparation according to the disclosure.

FIG. 2 is a black apple slice without skin prepared according to the disclosure.

FIG. 3 is a black apple slice with skin prepared according to the disclosure.

FIG. 4 is a black apple slice with skin prepared according to the disclosure.

FIG. 5 is a black apple slice (sprayed with maltodextrin powder) without skin prepared according to the disclosure

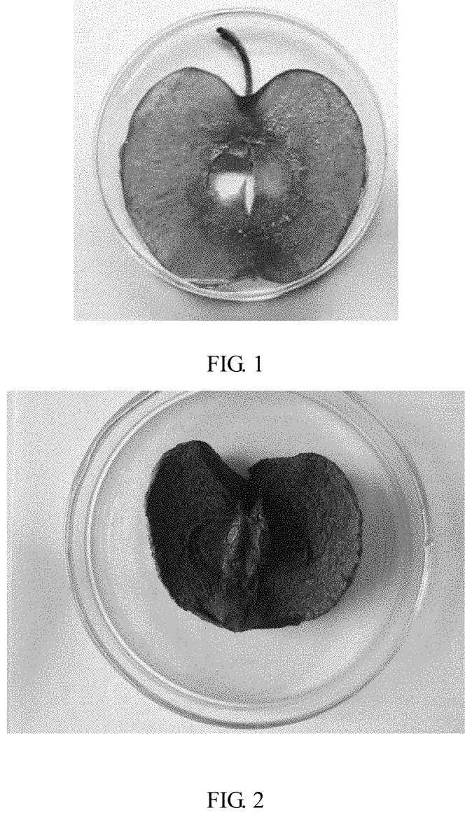

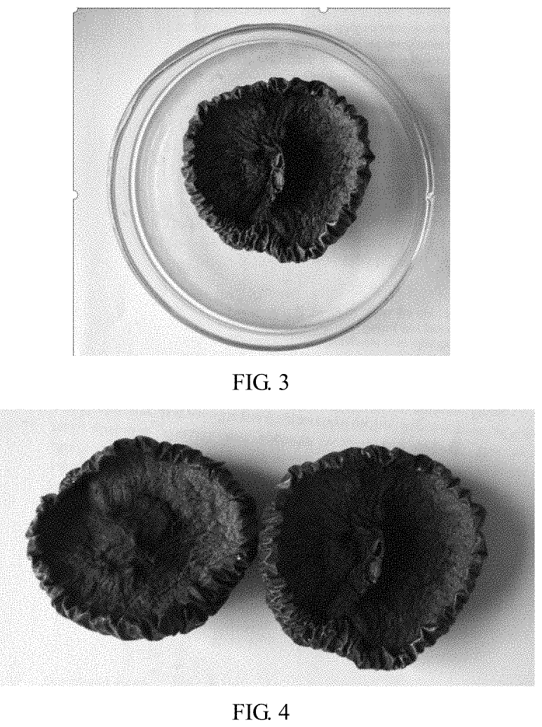

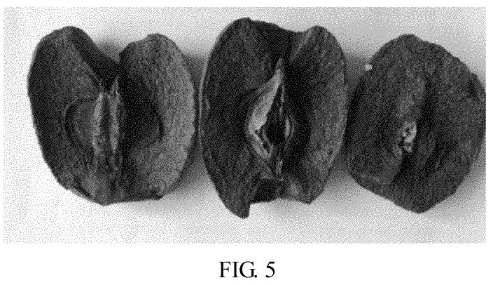

### DETAILED DESCRIPTION OF PREFERRED EMBODIMENTS

Next, the disclosure will be described in detail through examples, the following examples are only illustrative but not limiting, and cannot hereby limit the protective scope of the disclosure.

Provided are a high-bioactivity black apple chip and a processing technological process thereof. The processing process is as follows: fresh fruits→sorting→peeling→slicing→fermenting→drying→packaging→black dry apple chips.

Specific process requirements and parameters are as follows:

(1) sorting: selecting fresh and high-quality tangxin apples with no disease and pest invasion, no mechanical damage and roughly same fruit maturity.

(2) cleaning and peeling: under the running tap water, washing away the soil on the surface of apple, wiping the water drop, and peeling off the skin, wherein the thicknesses of peeled skins are maintained to be consistent to the greatest extent.

(3) slicing: slicing the apple to a thickness of 2 mm by using an ultra-high pressure water jet cutting technology. The integrity of cells is maintained, nutrients are not lost, the sliced surface is washed and grinded utilizing high-pressure water while cutting.

(4) fermenting: 360° atomizing the two sides of the apple slice under the condition of 60° C.-80° C. using a high-temperature Bacillus subtilis fermentation broth atomization spray technology, and irradiating the cut apple slices with 60 Coy rays at a dose of 4 kGy to promote carbonyl ammonia reaction so as to make the apple slices generate burnt black.

The object of adoption of irradiation is as follows: the energy released by radiation allows a glycoside bond in tangxin apple to be broken to release carbonyl, carbonyl further react with amino compounds to accelerate the carbonyl ammonia reaction of tangxin apple, and shorten the time for producing burnt black by apple slices.

(5) drying: a radio frequency-pulse vacuum dehumidification plate type drying technology is adopted, the vacuumizing combined with radio frequency is 30 MHz, and the radio frequency power is 5 kW pulse. Through the dehumidification plate type drying technology, the black apple slices are intermittently heated and dried, the heating temperature is 45° C., and the intermittently alternating time is 60 s.

In the process of drying, maltodextrin is preferably added, maltodextrin is sprayed to two sides of apple slices using a spraying manner to prevent the direct adhesion of apple slices.

(6) Packaging: packaging to obtain dry black apple chips.

Aiming at the above process, the related description of the disclosure is as follows:

1. Inoculating Bacillus subtilis to Produce an Enzyme System in High Yield and Effectively Accelerate Carbonyl Ammonia Reaction

Bacillus subtilis (ATCC 6633); function and characteristics: it produces α-amylase, cellulose and protease, and secretes active antibacterial substances; it is high in safety, has no toxicity, no residue, resistance to adverse environment, such as heat, UV, ionizing radiation, and is high in temperature and stable. The fermentation broth is used after strains are filtered, and α-amylase produced by the fermentation broth is mainly utilized.

Under the condition of 60° C.-80° C., the fermentation broth of Bacillus subtilis 360° atomizes tangxin apple slices, infiltrates into the cell to produce a large number of α-amylase which hydrolyzes starch chain to allow the starch chain to be broken so as to produce a large number of oligosaccharides and free carbonyls. Meanwhile, Bacillus subtilis secretes protease to hydrolyze nucleotides to generate a large number of free amino groups, thereby promoting carbonyl ammonia reaction and generation of melanoidin and shortening the reaction time; the apple slices are irradiated with 60 Coy rays at a dose of 4 kGy to further promote the carbonyl ammonia reaction so as to result in the formation of burnt black and special flavor on the surface of apple slices. Effects and advantages are as follows: the difference between temperatures is 10° C., the difference between carbonyl ammonia reaction speeds is 3-5 times, the higher the temperature is, the faster the reaction speed is. Bacillus subtilis fermentation atomization liquid can produce α-amylase and protease in high yield, hydrolyze substances such as saccharide compounds and protein, effectively and continuously supply carbonyl and amino, and produce a large number of active antibacterial substances; meanwhile energy released by irradiation allows the glycoside bond of apple slices to be broken to release carbonyl which can further react with amino compounds to accelerate carbonyl ammonia reaction, and shorten the generation time of black apple slices.

2. Radio Frequency-Pulse Vacuum Dehumidification Plate Type Pre-Drying Combined with Differential Pressure Puffing Technology

The vacuumizing combined with radio frequency is 30 MHz, and the power is kW pulse. Through the dehumidification plate type drying technology, the black apple slices are intermittently heated and dried, the heating temperature is 45° C., and the intermittently alternating time is 2 min.

The pressure differential puffing after vacuum pulse pre-drying is based on principle of “popcorn”. When in puffing, the pretreated apple slices are heated by steam in a vacuum airtight environment to continuously evaporate the internal moisture to generate water vapor. When the pressure keeps rising, and the temperature reaches 85-89° C., and the steam pressure reaches 0.3-0.4 MPa, the pressure is immediately reduced to −0.08 MPa, and the temperature is decreased to 75° C., and lasting for 1.5 h. The water inside apple slices is suddenly vaporized and flashed so as to generate a strong vapor pressure difference, which can keep nutrition, fresh flavor thorough dehydration, taste crisp, full shape and even puffing of apple.

Effects and advantages are as follows: vacuum environment reduces the activity of enzyme without affecting product quality. The pulse radio frequency has great penetration ability and even heating. Meanwhile, addition of maltodextrin can effectively solve the problem that the apple slices are adhered in the process of drying due to its too high sugar content, thereby improving the retention and uniformity of nutrition components in the dried products, and significantly shortening the drying time by about 50%. If the differential pressure puffing operating temperature is too low, the puffing degree is low. The appearance and crispness of apple chips are poor. When the operating temperature is too high, the coking is easily formed. The combination of the two can overcome the problems of “hard core” and “coking” caused by RF-pulse and differential pressure puffing.

3. Bacteriostasis and Antisepsis of Bacillus subtilis Antimicrobial Peptide

Bacillus subtilis antimicrobial peptide is obtained by fermentation of Bacillus subtilis (BNCC 189983). As a new food preservative, the Bacillus subtilis antimicrobial peptide has the advantages of no toxicity, no residue and no drug resistance. The Bacillus subtilis antimicrobial peptide is significant in antibacterial effect, short in production cycle and low in cost, and can reduce the energy consumption in the process of food cold chain transportation.

The apple chips are evenly sprayed with 1.2 g/L of Bacillus subtilis antimicrobial peptide solution, dried for 5 min in air at 40° C., and dried for 0.5 h in hot air. Advantages and effects are as follows: natural microbial preservative has wide antibacterial spectrum, short production cycle and no toxicity, and can effectively perform bacteriostasis and antisepsis.

4. Index Determination

(1) Fermentation Time

| Treatment | Fermentation time |
|---|---|
| Inoculate Bacillus subtilis | 3 d |
| Control group | 5 d |

Inoculation of Bacillus subtilis can effectively shorten fermentation time.

(2) Total Bacterial Counts of Apple Chips after being Preserved for 3 Months

| Treatment | Total bacterial counts (CFU/ml) |
|---|---|
| Bacillus subtilis antimicrobial peptide | 2.89 × 10² |
| Control group | 8.16 × 10⁴ |

Inoculation of Bacillus subtilis antimicrobial peptide can obviously inhibit the growth of bacterial numbers.

(3) Sensory Quality of Products after being Preserved for 3 Months

| Index | | Score |
|---|---|---|
| Color (10 scores) | Color is even, coloring is black | 8.5 |
| | and bright | |
| Flavor (10 scores) | Fragrance is thick, no other bad | 8 |
| | odors that do not meet this | |
| | product | |
| Taste(10 scores) | Taste is palatable without odor | 8.5 |
| Hardness(10 scores) | Crisp, tasty and refreshing, no | 8 |
| | adhesion to teeth | |

Note:
full mark of each index is 10 scores.

After being preserved for 3 months, the sensory quality of the product is good.

We claim:

1. A processing method of a high-bioactivity black dry apple chip, wherein specific process requirements and parameters are as follows:
(1) sorting: selecting fresh and high-quality tangxin apples with no disease and pest invasion, no mechanical damage and roughly same fruit maturity;
(2) cleaning and peeling: under the running tap water, washing away the soil on the surface of apple, wiping the water drop, and peeling off the skin;
(3) slicing: slicing the apple to a thickness of 2 mm by using an ultra-high pressure water jet cutting technology;
(4) fermenting: atomizing the two sides of the apple slice under the condition of 60° C.-80° C. using a high-temperature Bacillus subtilis fermentation broth atomization spray technology, irradiating the cut apple slices with 60 Coy rays at a dose of 4 kGy to promote carbonyl ammonia reaction, so as to make the apple slices generate burnt black;
(5) drying: a radio frequency-pulse vacuum dehumidification plate type drying technology is adopted, vacuumizing combined with radio frequency is 30 MHz, and the radio frequency power is 5 kW pulse. Through the dehumidification plate type drying technology, the black apple slices are intermittently heated and dried, the heating temperature is 45° C., and the intermittently alternating time is 60 s.
(6) packaging: packaging to obtain black apple chips.

2. The processing method of the high-bioactivity black dry apple chip according to claim 1, wherein when the fermentation temperature is 85˜89° C. and the steam pressure is 0.3˜0.4 MPa, the pressure is instantly reduced to −0.08 MPa, and the temperature is decreased to 75° C., lasting for 1.5 h.

3. The processing method of the high-bioactivity black dry apple chip according to claim 1, wherein maltodextrin powder is sprayed in the process of drying.
